(19) United States
(12) Patent Application Publication
(10) Pub. No.: US 2017/0017558 A1
(43) Pub. Date: Jan. 19, 2017

(54) NON-INTRUSIVE PROBE FOR DOUBLE DATA RATE INTERFACE

(71) Applicant: QUALCOMM Incorporated, San Diego, CA (US)

(72) Inventors: Chong Ding, Cary, NC (US); Douglas Bruce White, Raleigh, NC (US); Roy Draughn, Cary, NC (US)

(21) Appl. No.: 14/922,400

(22) Filed: Oct. 26, 2015

Related U.S. Application Data
(60) Provisional application No. 62/193,896, filed on Jul. 17, 2015.

(51) Int. Cl. G06F 11/263; G06F 11/22

(52) U.S. Cl. CPC G06F 11/263; G06F 11/221

(57) ABSTRACT

A method and apparatus using a non-intrusive probe for testing double data rate interfaces is provided. The method begins with the generation of at least one component parameter model, which is then cascaded to form a full system parameter model of the double data rate interface being tested. Transfer functions are generated using the full system parameter model. A target transfer function is calculated between the test equipment and a decision point. The calculated target transfer function is applied and testing is completed. The apparatus includes a device to be tested, mounted on a circuit board. A probe card is attached to the backside of the circuit board and is in communication with a high-speed connector. At least one connector in communication with the high-speed connector and at least one small footprint RF connector on an accessible side of the circuit board are also part of the non-intrusive probing apparatus.

### BACKGROUND INFORMATION

Technical Field

The present invention relates generally to high-speed signal measurement, and more particularly to a non-intrusive probing method and apparatus for testing double data rate devices.

Background Information

As mobile phones and other electronic devices incorporate more features and applications the need grows for extensive testing of the chips within the devices as well as the devices themselves. To support this increased performance, memory interface speeds have increased to multi-giga bits per second (Gbps). At such high speeds double data rate memories and interfaces are used. The signal quality of the memory interfaces must be checked to ensure that the data is transmitted and received correctly.

A computer or device bus operating with a double data rate transfers data on both the rising and falling edges of the clock signal. This allows twice as much data to be transferred. The simplest way to design a clocked electronic circuit is to make the circuit perform one transfer per full cycle (rise and fall) of a clock signal. However, this requires that the clock signal change twice per transfer, while the data line changes at most once per transfer. When operating at a high bandwidth, signal integrity limitations constrain the clock frequency. By using both edges of the clock, the data signals operate with the same limiting frequency, thereby doubling the data transmission rate.

Signal quality is usually checked using a probe. Ideally, a probe is placed as near as possible to the signal reception point or other point of interest for testing. In many cases the probe used for testing double data rate devices is known as a middle bus probe. Testing using a middle bus probe requires inserting a bus probe in the middle of a channel. In order to place the probe in the middle of the channel a large profile footprint must be reserved on the target circuit board. Placing the large profile footprint changes the characteristics of the target channel because the speed and distance a signal must travel to be measured. Because the middle bus probe is intrusive to the original channel it is typically used for very low speed protocol diagnosis.

An alternative to the middle bus probe is to solder a high bandwidth probe with low parasitic characteristics to the circuit board. The sampled signal is then fed into a high-speed digital scope. The attaching of the probe is tedious and time consuming and is not suitable for double data rate bus interfaces since multiple pins need to be measured at the same time. A more significant issue is that the location of interest for examining the signal is not normally accessible. As a result the measurement is taken close to, but some distance away from the desired location. Often this situation arises because the preferred location for the test probe may be located on the back of the silicon die, where it cannot be probed.

There is a need in the art for a method and apparatus for non-intrusive probing for double data rate interfaces.

### SUMMARY

Embodiments described herein provide a non-intrusive probe for testing double data rate interfaces and a method for using the probe during testing. The method begins with the generation of at least one component parameter model. The component parameter model is then cascaded to form a full system parameter model of the double data rate interface being tested. Transfer functions are then generated based on the full system parameter model. A target transfer function is then calculated between test equipment and a decision point. The calculated target transfer function is then applied and the testing is completed.

A further embodiment provides an apparatus for testing double data rate interfaces. The apparatus includes a device to be tested, mounted on a circuit board. A probe card is attached to the back side of the circuit board and is in communication with a high-speed connector. At least one connector in communication with the high-speed connector and at least one small footprint RF connector on an accessible side of the circuit board are also part of the non-intrusive probing apparatus.

A still further embodiment provides an apparatus for testing a high-speed interface. The apparatus includes: means for generating at least one component parameter model; means for cascading the at least one component parameter model to form a full system parameter model; means for generating transfer functions based on the full system parameter model; means for calculating a target transfer function between a test equipment and a decision point; and means for applying the target transfer function between the test equipment and the decision point.

### BRIEF DESCRIPTION OF THE DRAWINGS

FIG. 1 illustrates the effect of measurement at a distance from a desired location, in accordance with embodiments disclosed herein.

FIG. 2 depicts a non-intrusive probe for double data rate interfaces, in accordance with embodiments disclosed herein.

FIG. 3 shows the probe in relation to the target circuit board, in accordance with embodiments disclosed herein.

FIG. 4 illustrates using a transfer function in conjunction with the non-intrusive probe, in accordance with embodiments disclosed herein.

FIG. 5 shows the effect of the transfer function on a test signal, in accordance with embodiments disclosed herein.

FIG. 6 is a flowchart of the generation of the transfer function, in accordance with embodiments disclosed herein.

FIG. 7 depicts the results of the characterization of the transfer function, in accordance with embodiments disclosed herein.

FIG. 8 shows the results of removing the probe loading effect on the test signal, in accordance with embodiments disclosed herein.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Exemplary embodiments, as described herein are directed toward a non-intrusive probe for use with double data rate interfaces. The embodiments described herein provide a non-intrusive, bus interface compatible probing solution that is simple to use and low-cost. The embodiments also incorporate transfer functions for use with the channel being tested. The embodiments described herein provide significant advantages over existing methods. First, the probe may be attached to any accessible location along the path of a channel, and need not be located near the device being tested. Second, the embodiments are non-intrusive, as the apparatus and methods do not modify the target channel. The embodiments require knowledge of the transfer functions of the channel, the probe, and the termination impedances. The channel model may be obtained from three-dimensional structural simulations, and the termination data is available from manufacturer data sheets.

A transfer function is a mathematical representation for fit. It is also used to describe black box model outputs. Typically, it is a representation in terms of spatial or temporal frequency, of the relation between the input and the output of a linear time-invariant system with zero initial conditions and zero-point equilibrium. In other cases, a transfer function may also means some input-output characteristic in direct physical measurement, rather than a transformation to the s-plane. In the embodiments described below, however, the transfer function is a transformation to the s-plane.

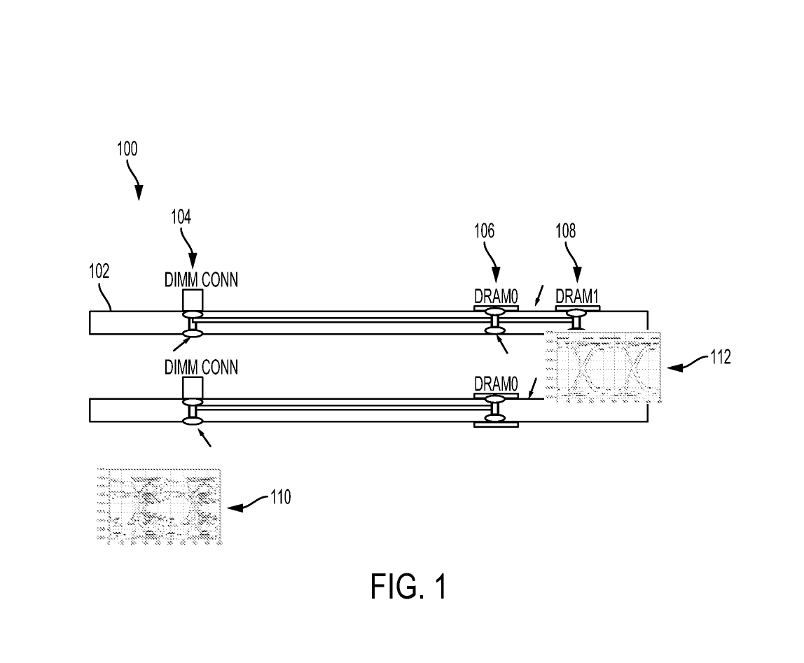

FIG. 1 illustrates the problems with conventional testing solutions for high-speed double date rate interfaces. The assembly 100, includes die 102 and dual in-line memory module (DIMM) connector 104. Die 102 also includes first digital random access memory (DRAM) 106 and second DRAM 108. A first signal plot 112 shows the high speed signal measured at the probe location near DRAM 106 and DRAM 108. As shown in signal plot 112 the signal has certain specific characteristics that are clearly seen in the signal plot 112. A second signal plot 110 is obtained at DIMM connector 104. Ideally, the high-speed signal should be probed on the die of DRAM 108 for a “write” operation, because that is where the signal is sampled by the receiver. In many cases, the die is encapsulated and there is no suitable location to attach the probe. Often the probe is attached as close as possible to the encapsulated die, but this may cause further problems. A signal measured some distance from the DRAM 108, such as shown in second signal plot 110 may not display the same characteristics. In particular, some signal problems may be obscured. This is evident in second signal plot 110, which appears to have distortion, and may include noise. The need to sample the signal at the die arises because that is the location that is sampled by the receiver. Speed and distance affect the signal being probed and this problem only becomes more acute as the interface speed increases. This change in signal away from the die is shown in FIG. 1.

A side view illustrates the mounting of the DIMM connector 204 and the controller footprints as well as the mounting of the probe card 206, the small footprint RF connectors 208, and the micro pogo or micro spring connectors 210. Probe card 206 may be mounted to a device under test using screws 212 passing through mounting hole 214. A further embodiment allows for magnetic mounting.

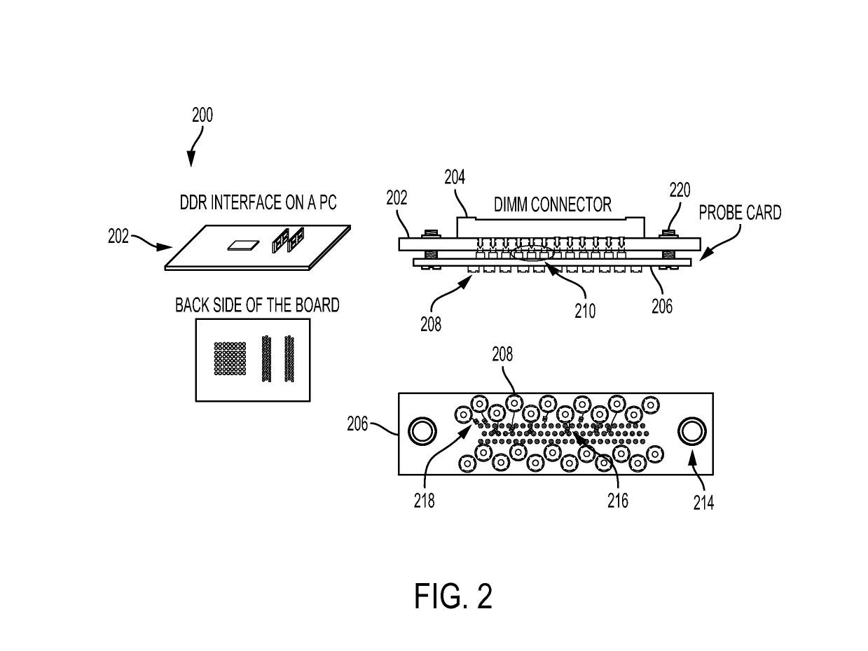

FIG. 2 illustrates an assembly 200 that depicts a typical DDR interface on a printed circuit board 202 with one controller and two dual in-line memory modules (DIMM). A back view of the circuit board is also depicted in FIG. 2. The probe card 206, illustrated in FIG. 2 is a small printed circuit board that is matched to the footprint of the DIMM connector 204 or the controller. On the other side of the probe card, a small footprint (for example, 0201) 450-ohm series resistor 216 conducts the measured signal to the small RF connectors 208. Other resistor values may be needed for different signals. These small RF connectors 208 may be SMP connectors, or may be other suitable small footprint connectors, depending on the signal being tested. The probe card 206 includes the small footprint RF connectors 208, microstrips 218, and series resistors 216. The DIMM connector 204 is mated to a coaxial cable that feeds the signal into the oscilloscope or other test equipment used to check the signals. In order to ensure good contact with the vias of the DIMM connector 204, the probe should be lightly pushed against the target circuit board, and screws 220, shown in FIG. 2, may be used to accomplish this. Other holding devices such as clamps or magnets may be used to provide the contact force. The assembly 200 provides good signal integrity and full access to all of the pins of the DDR interface and does so without the need to modify the target board.

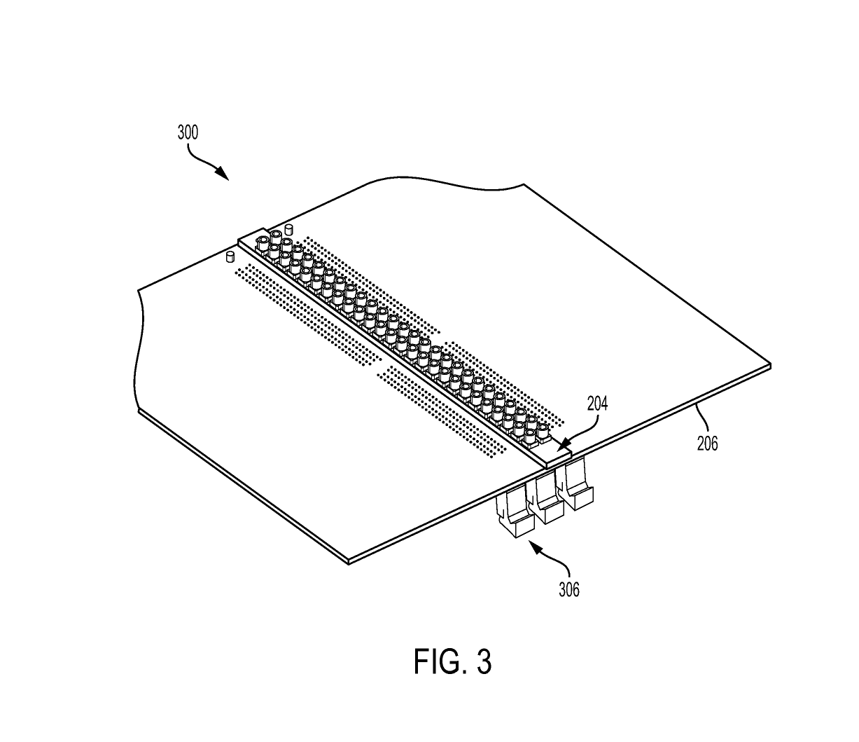

FIG. 3 shows a three-dimensional view of probe card assembly 300. Probe card 206 has DIMM connector 204 mounted to the probe card 206. The assembly 300 is attached to the device under test using the press insertion mounting feet 306. The through hole via from the controller and the DIMM connectors footprints provide a free access probing point, as depicted in the top view of the probe card mounting, shown in FIG. 2. A transfer function is applied at the free access probing point. The transfer function is used to project the signal at the dies for both the dynamic random access memory (DRAM), and the memory controller.

FIG. 3 shows a three-dimensional view of the probe positioned on top of the target board. This figure shows the relationship of the probe card and the connector. As shown in FIG. 3 the probe design is non-intrusive and makes use of the DIMM connector pins, eliminating the need to modify the board being tested. In addition, good signal integrity is provided by the apparatus. FIG. 3 also shows that full access to all pins of the DDR interface is provided.

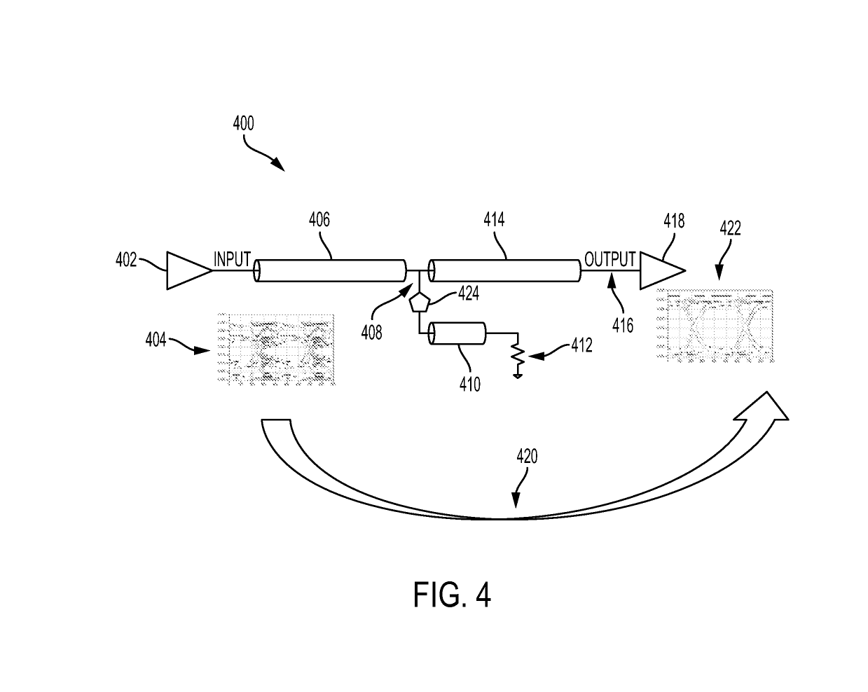

FIG. 4 shows the relationship between the probing embodiments described above with the transfer function, as assembly 400. The transfer function uses the transfer function of a linear time-invariant system (LTI). In a LTI system, the relationship between the input (X) and the output (Y) may be described as:

Ys=H(s)X(s)

where X(s) is the Laplace transform of the continuous-time input signal x(t). The same holds true for Y(s). H(s) is the transfer function and represents the linear mapping of the Laplace transforms of the input to the Laplace transform of the output.

Transfer functions have been widely used in communication system analysis. In FIG. 4 a channel is shown. The input 402 of the channel is connected to a signal driver or transmitter, and the output 418 is connected to the receiver. The pentagon shape 424 represents the complete probe card assembly 206, shown in FIG. 2, and is attached at the DIMM connector 206 footprint on the back side of the target printed circuit board. This is shown in FIG. 3. The measuring point (MP) 408 shows where the probe is attached in FIG. 4. The decision point (DP) 416 or sample point is where the signal is sampled by the receiver and is the point of interest for the test. The first green segment 406 prior to MP 408 and the second green segment 414 after the MP 408 are the passive channel. The coaxial cable 410 connects the probe RF connector and the oscilloscope 412. The coaxial cable 410 feeding the oscilloscope or test equipment is typically 50 ohm terminated, however the value of the coaxial cable may change depending on the specific test needs. Between the three ports (input 402, DP 416, and MP 408), only two transfer functions need to be characterized, the third transfer function may be calculated from the other two transfer functions. The screen 404 of the oscilloscope shows the signal at the MP 408, prior to the application of the transfer functions. The second view of the signal is 422 and gives the view of the signal after application of the transfer functions 420, which may be directly applied to the oscilloscope waveform to project the signal on the die. This operation may be performed directly on the oscilloscope or other test equipment, or may be performed using a mathematical software program.

The probe card 206 in FIG. 2 provides a physical path to measure the signal with the oscilloscope or other test equipment, one from the input to the output, and the other from the input to the oscilloscope. It may be necessary to remove the effects of probe loading to estimate the production performance of the device being tested. The two transfer functions are discussed below.

The output of the transfer function provides:

Output=TF(CHLBP+PROBE CKT_terminated+CHLAP)*Input

where CHLPB is the channel model from the input to the MP, PROBE CKT_terminated is the probe circuit including the cabling to the oscilloscope and the oscilloscope termination, CHLAP is the channel model from the MP to the output. The receiver input impedance is typically known to the user. The transfer function of the scope may be provided by the equation below:

Scope=TF(CHLBP+PROBE CKT+CHLAP terminated)*Input, with the “+” sign in the equations above representing cascading.

With both of the equations above, the relation between the output and the scope may be described by the equation below:

Output=TF(CHLBP+PROBE CKT terminated+CHLAP)/TF(CHLBP+PROBE CKT+CHLAP terminated)*Scope

The above equation provides that measurements may be made at any location along the channel and then the transfer functions are used to project the signal at the target location, typically on-die.

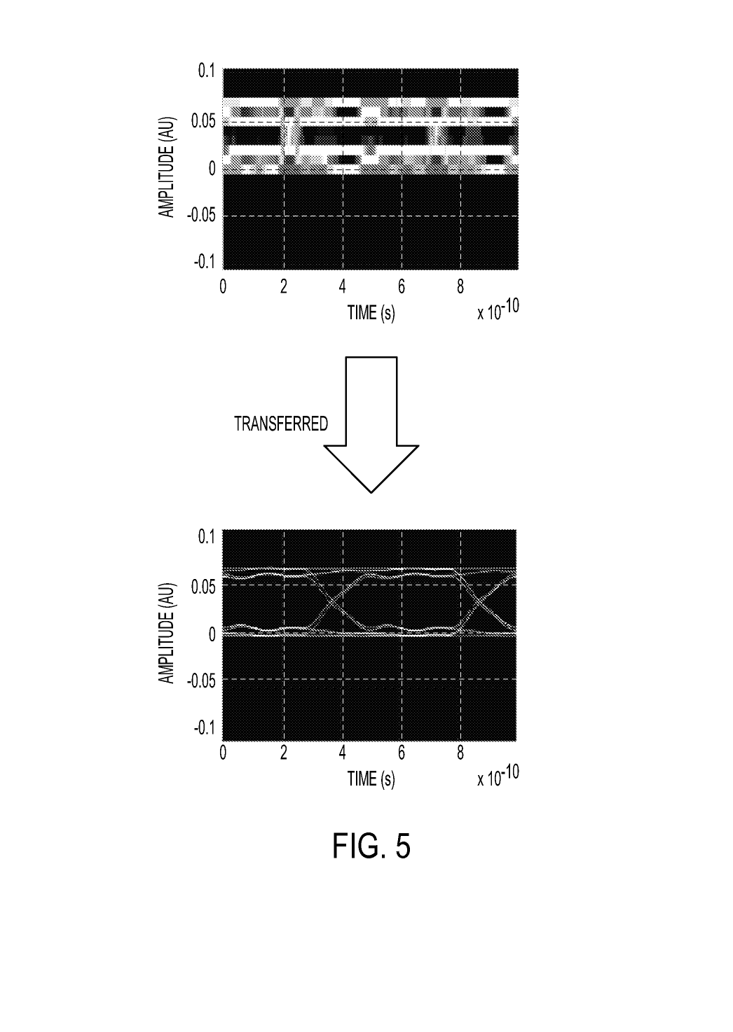

FIG. 5 shows the signal as measured at the probing point, in the first illustration and also shows the signal after the transfer function operations have been completed in the second illustration. In detail, the transfer function mathematics is given below:

$$TF = \frac{{S}_{21} ( 1 + {Γ}_{L} ) ( 1 + {Γ}_{S} )}{2 ( 1 - {S}_{22} {Γ}_{L} ) ( 1 - {Γ}_{IN} {Γ}_{S} )}$$

$${Γ}_{L} = \frac{{Z}_{L} - {Z}_{0}}{{Z}_{L} + {Z}_{0}} and {Γ}_{S} = \frac{{Z}_{S} - {Z}_{0}}{{Z}_{S} + {Z}_{0}}$$

$$Γ = {S}_{11} + \frac{{S}_{12} {S}_{21} {Γ}_{L}}{1 - {S}_{22} {Γ}_{L}}$$

The mathematics of the transfer functions are given below:

Output_signal=TF (input2output)*Input

Probe_signal=TF (input2probe)*Input

Output_inferred=(TF (input2output)/TF(input2probe))*probe_signal

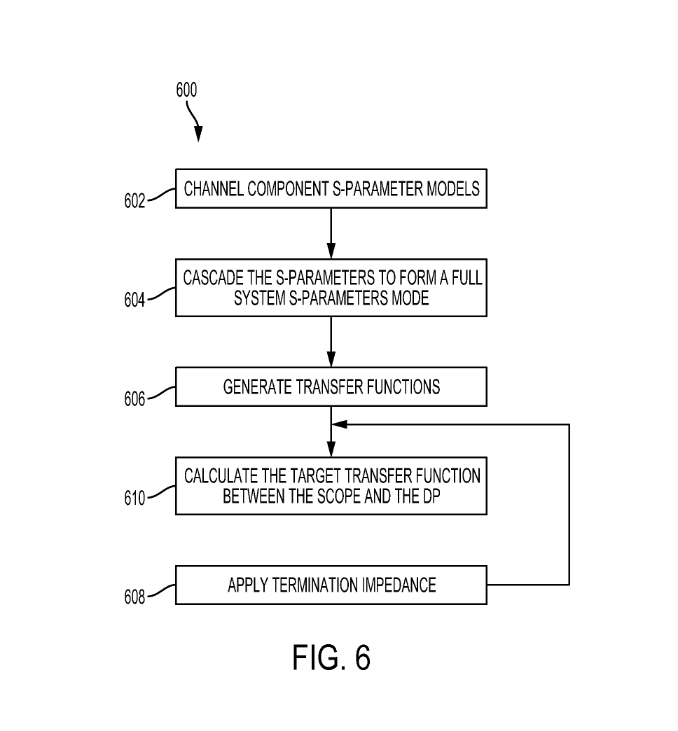

FIG. 6 is a flowchart of the process used to generate the transfer functions. The process 600 begins with the collecting or generating numeric models of the channel components in step 602. These are the channel component S-parameter models that will be used in forming the system S-parameter model. The channel component S-parameter models for the printed circuit board traces, packages, connectors, and other components, are collected. These parameters may be measured, simulated, or provided by the component vendors. The next step 604, cascades the S-parameters to form a full system S-parameter model.

Once the full S-parameter model has been obtained, the transfer functions are generated in step 606. Transfer functions are generated between the input and output (TF1), the input and the scope (TF2) and the input and output (TF3) with the probe removed. The target transfer function is then calculated between the scope and the DP: TF1/TF2, TF3/TF2 (with probe loading removed). The termination impedance is applied in step 608. Once the target transfer function has been calculated and the termination impedance applied the method proceeds to step 610, where the target transfer function is calculated. The TF1/TF2 and TF3/TF2 (with probe loading removed) as used in the calculation in step 610. The calculated transfer function may be directly applied to the oscilloscope waveforms to project the on-die signal. This step may be performed on a commercial oscilloscope with transfer function capability or may be performed by downloading the oscilloscope waveforms and then using a mathematics-processing program.

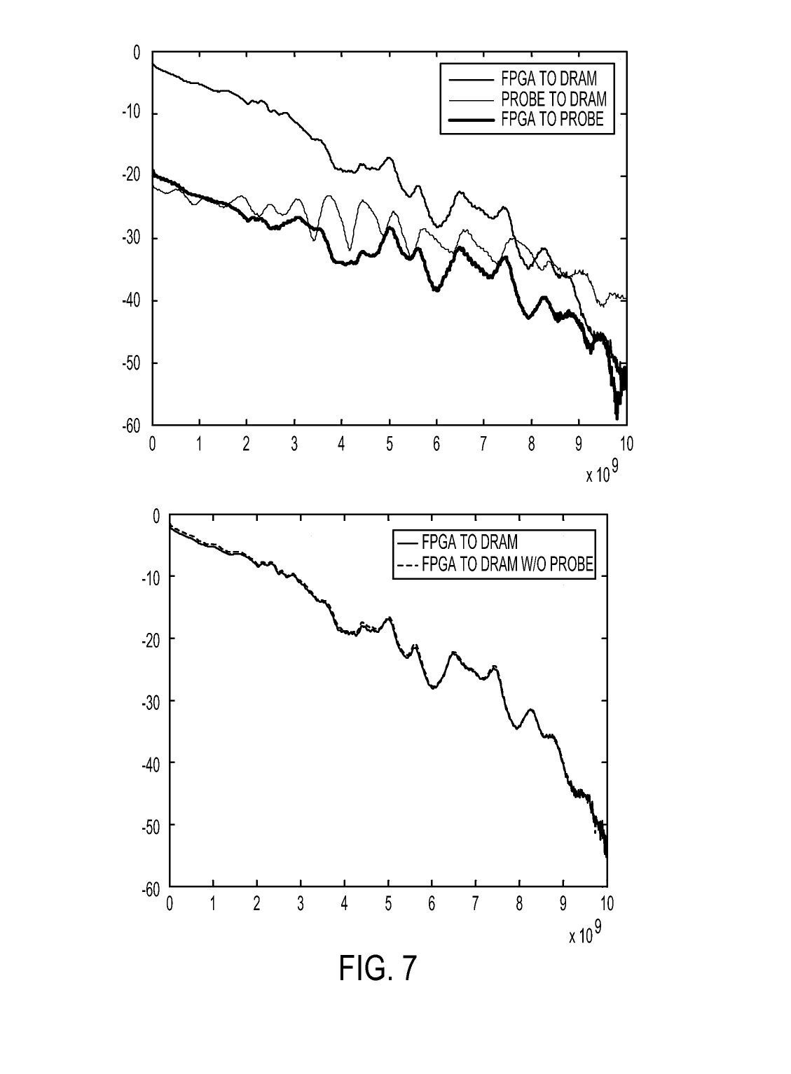

FIG. 7 shows the transfer function characterization set up plots. The graph on the left shows three plots, the field programmable gate array (FPGA, in place of a memory controller chip) to DRAM transfer function, the probe to the DRAM transfer function, and the FPGA to probe transfer function. The plot on the right shows the characterized setup with near matching plots for FPGA to DRAM and FPGA to DRAM without probe plots.

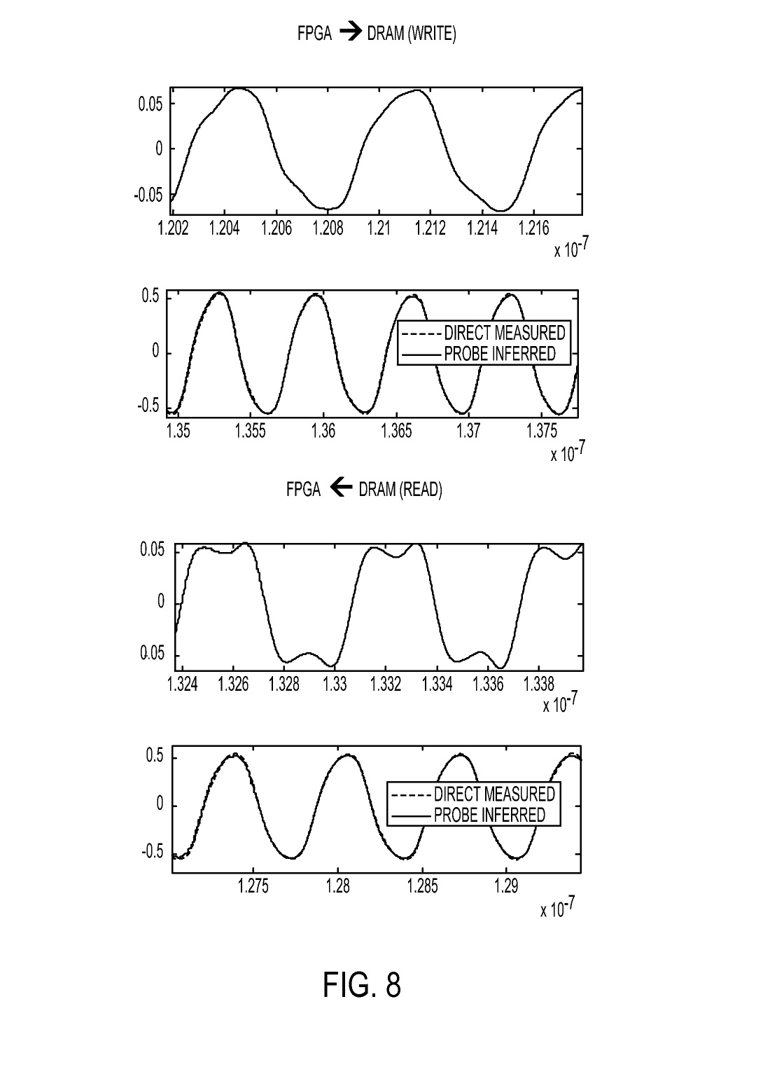

FIG. 8 depicts laboratory experiment results of applying the transfer functions. Probe loading effects have been removed for these plots. Plots are provided for FPGA to DRAM probe measured signal during a write operation to the DRAM. A similar plot is shown for the read operation. Further plots are provided showing the matching direct measured signal overlaying the probe inferred signal. Separate plot are shown for the write operation and the read operation.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The processor may be, or may include, a digital signal processor (DSP). The processor may include an amount of special dedicated hardware that performs some selected amount of the processing in hardware rather than in software or firmware.

Although certain specific embodiments are described above for instructional purposes, the teachings of this patent document have general applicability and are not limited to the specific embodiments described above. Accordingly, various modifications, adaptations, and combinations of the various features of the described specific embodiments can be practiced without departing from the scope of the claims that are set forth below.

What is claimed is:

1. A method of testing a high-speed interface, comprising:
generating at least one component parameter model;
cascading the at least one component parameter model to form a full system parameter model;
generating transfer functions based on the full system parameter model; and
calculating a target transfer function between a test equipment and a decision point; and
applying the target transfer between the test equipment and the decision point during testing.

2. The method of claim 1, wherein the transfer functions include transfer functions between an input and an output of the device being tested, an input of the device being tested and a test equipment, and an input and output of the device being tested.

3. The method of claim 1, wherein the transfer function of the input and output of the device being tested has removed a probe loading effect from the transfer function.

4. The method of claim 1, wherein the transfer function is based on the point at which a probe is inserted and the decision point.

5. The method of claim 1, wherein the component parameter models are S-parameter models.

6. The method of claim 5, wherein the S-parameter models are measured for each component.

7. The method of claim 5, wherein the S-parameter models are derived from a simulation.

8. The method of claim 5, wherein the S-parameter models are based on vendor data for each component.

9. An apparatus for testing a high-speed interface, comprising:
a device to be tested, mounted on a circuit board;
a probe card, attached to a back side of the circuit board, in communication with a high-speed connector;
at least one connector in communication with the high-speed connector; and
at least one small footprint RF connector on an accessible side of the circuit board.

10. The apparatus of claim 9, wherein the probe card includes resistors in series with the at least one small footprint RF connector.

11. The apparatus of claim 9, wherein the probe card is mounting using probe card mounting holes.

12. The apparatus of claim 9, wherein the probe card is mounted using magnetic plates.

13. The apparatus of claim 10, wherein the resistors are mounted using microstrips.

14. An apparatus for testing a high-speed interface, comprising:
means for generating at least one component parameter model;
means for cascading the at least one component parameter model to form a full system parameter model;
means for generating transfer functions based on the full system parameter model; and
means for calculating a target transfer function between a test equipment and a decision point;
means for applying the target transfer function between the test equipment and the decision point.

15. The apparatus of claim 14, wherein the means for generating transfer functions generates transfer functions between an input and an output of the device being tested, an input of the device being tested and a test equipment, and an input and output of the device being tested.

16. The apparatus of claim 14, wherein the means for generating transfer functions of the input and output of the device being tested removes a probe loading effect from the transfer function.

17. The apparatus of claim 14, wherein means for generating transfer functions bases the transfer functions on the point at which a probe is inserted and the decision point.
